(19) United States
(12) Patent Application Publication
(10) Pub. No.: US 2015/0066290 A1
(43) Pub. Date: Mar. 5, 2015

(54) INDICATION SYSTEM FOR A MACHINE

(71) Applicant: Caterpillar SARL, Geneva (CH)

(72) Inventors: THOMAS S. RUFFNER, Washington, IL (US); Shaun A. Smyth, Darlington Co. (GB); Kurt L. Winckler, Washington, IL (US); Anthony S. Cooksey, Metamora, IL (US); James Tarelli, Darlinton (GB); Thomas R. Springer, Pekin, IL (US)

(73) Assignee: Caterpillar SARL, Geneva (CH)

(21) Appl. No.: 14/536,749

(22) Filed: Nov. 10, 2014

(51) Int. Cl. B60Q 1/50; B60Q 1/26; G05D 25/02

(52) U.S. Cl. CPC B60Q 1/50; G05D 25/02; B60Q 1/2611
USPC 701/33.9

(57) ABSTRACT

A light indicator system for a machine is disclosed. The light indicator system includes a single light assembly positioned on an exterior facing surface of an operator cab of the machine. The light assembly is positioned such that it is viewable from outside the machine. The light indicator system also includes a payload monitoring module configured to generate a signal indicative of an amount of payload on the machine. The light indicator system further includes a transmission module configured to generate a signal indicative of a mode of operation of the machine. The light indicator system includes a controller communicably coupled to the light assembly, the payload monitoring module, and the transmission module.

### TECHNICAL FIELD

The present disclosure relates to an indicator system, and more particularly to a light indicator system provided on a machine.

### BACKGROUND

During a loading operation of a machine, it may be required to load the machine with an optimum amount of payload. An overloaded condition of the machine may affect the machine, and sometimes create a general depression or subsidence of the machine. Further, continuous overloading of the machine may even lead to damage or breakdown of the machine. Therefore, a loading tool operator, who resides outside of the machine, may have to be made aware of the amount of payload that is required to be loaded on to the machine, so that the machine does not exceed a threshold weight carrying capacity.

For this purpose, visual indication systems are provided on an exterior portion of the machine in order to make the loading tool operator aware of whether a loading capacity of the machine is met during the loading operation. Some machines make use of a three light payload monitor to provide a visual indication to the loading tool operator, in order to make the loading tool operator aware of when the loading capacity of the machine is met. However, these monitors are large, occupy space, and may also have additional costs associated therewith. The wiring and mounting of these monitors may be complex and cumbersome.

U.S. Pat. No. 4,835,719 describes a payload monitoring system of a work vehicle includes a software controlled method of predicting when one additional bucketload of material will properly fill the vehicle to its rated capacity. The system calculates the actual magnitude of each bucketload of material and adds that value to the present payload to predict the future payload resulting from an additional bucketload of material. When the predicted future payload encompasses the rated capacity, the system signals the operators of both the work vehicle and the loading vehicle that one additional pass will complete the loading process.

### SUMMARY OF THE DISCLOSURE

In one aspect of the present disclosure, a light indicator system for a machine is disclosed. The light indicator system includes a single light assembly positioned on an exterior facing surface of an operator cab of the machine. The light assembly is positioned such that it is viewable from outside the machine. The light indicator system also includes a payload monitoring module configured to generate a signal indicative of an amount of payload on the machine. The light indicator system further includes a transmission module configured to generate a signal indicative of a mode of operation of the machine. The light indicator system includes a controller communicably coupled to the light assembly, the payload monitoring module, and the transmission module. Further, the controller is configured to receive the signal indicative of the mode of operation of the machine. The controller is also configured to activate a first configuration of the light assembly during a traversal of the machine, such that in the first configuration, the light assembly is configured to display a first indication in a first color. The controller is further configured to activate a second configuration of the light assembly during a parking of the machine. In the second configuration, the controller is configured to display a second indication in a second color on the light assembly. The controller is also configured to receive the signal indicative of the amount of payload. The controller is further configured to compare the amount of the payload with a predetermined threshold. The controller is configured to change the second color to a third color based on exceeding the predetermined threshold.

Other features and aspects of this disclosure will be apparent from the following description and the accompanying drawings.

### BRIEF DESCRIPTION OF THE DRAWINGS

FIG. 1 is a side view of an exemplary machine, according to one embodiment of the present disclosure;

FIG. 2 is a perspective view of an operator cab of the machine of FIG. 1 having a light assembly mounted on a top portion of the operator cab; and

FIG. 3 is a block diagram of a light indicator system associated with the machine.

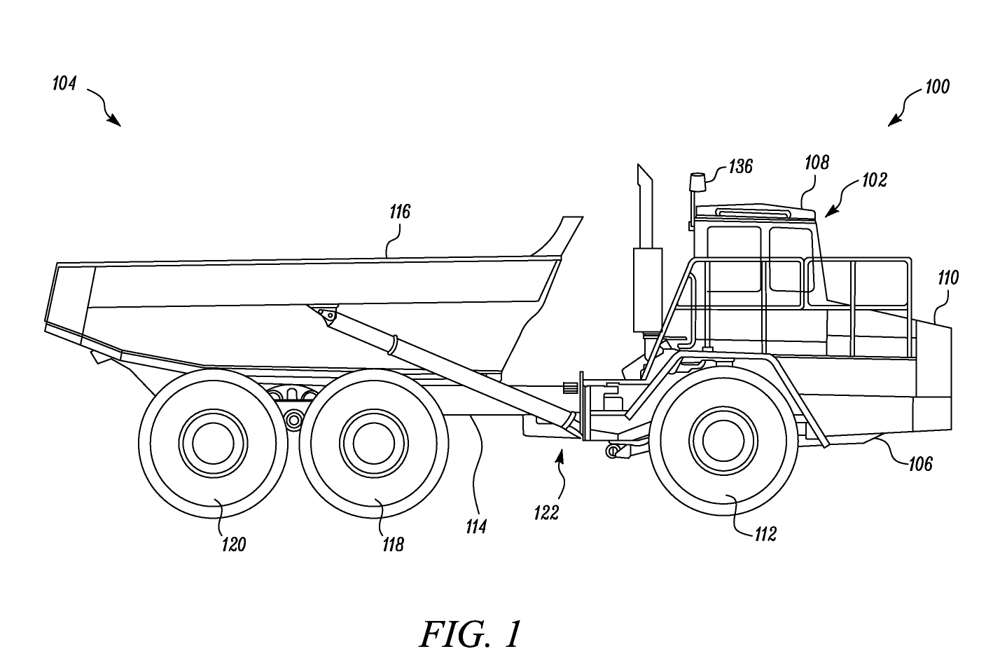

### DETAILED DESCRIPTION

Wherever possible, the same reference numbers will be used throughout the drawings to refer to the same or the like parts. FIG. 1 illustrates an exemplary machine 100. In the illustrated embodiment, the machine 100 is an articulated truck. A person of ordinary skill in the art will appreciate that the machine 100 depicted in the accompanying figures is merely on an exemplary basis and does not limit the scope of the present disclosure. Accordingly, the machine 100 may be any of a mining truck, an off-highway truck, a dump truck, a quarry truck, and the like. It should be noted that the disclosure can be applied to any number of different types of wheeled machines used in industries including, but not limited to, construction, transportation, agriculture, forestry, and waste management.

Referring to FIG. 1, the machine 100 may have a front section 102 and a rear section 104. The front section 102 may be provided with a front frame 106. An operator cabin 108 may be provided on the front frame 106 of the front section 102. The operator cabin 108 may house various controls of the machine 100. An enclosure 110 may be provided on the front section 102 which may house a power source (not shown). The power source may provide power to the machine 100 for mobility and/or other operational needs. The power source may include, for example, a diesel engine, a gasoline engine, a gaseous fuel powered engine such as a natural gas engine, a combination of known sources of power, or any other type of power source apparent to one skilled in the art. The power source may alternatively include a non-combustion source of power, such as, a fuel cell, a power storage device, an electric motor, or other similar mechanism. The front section 102 may further include a front wheel set 112. The front wheel set 112 may include wheels for manoeuvring of the machine 100 on ground.

The rear section 104 of the machine 100 may be provided with a rear frame 114. The rear section 104 of the machine 100 may include a payload carrier 116 provided on the rear frame 114. The payload carrier 116 may be configured to carry a payload from one location to another. Further the rear section 104 may include a centre wheel set 118 and a rear wheel set 120. The front and rear sections 102, 104 may be linked to each other by an articulated joint 122. The articulated joint 122 may permit relative movement between the front and rear sections 102, 104 about a vertical axis, enabling the machine 100 to be steered. The articulated joint 122 may also permit roll about a longitudinal axis thereby reducing stresses on the front frame 106 and/or the rear frame 114 and increasing wheel contact and traction. Additionally, elements of a powertrain (not shown) for example, a torque converter, transmission inclusive of gearing, one or more drive shafts, differentials, and other known elements of the powertrain may be provided on the machine 100 to transmit power from the power source to the front, centre, and/or rear wheel sets 112, 118, 120.

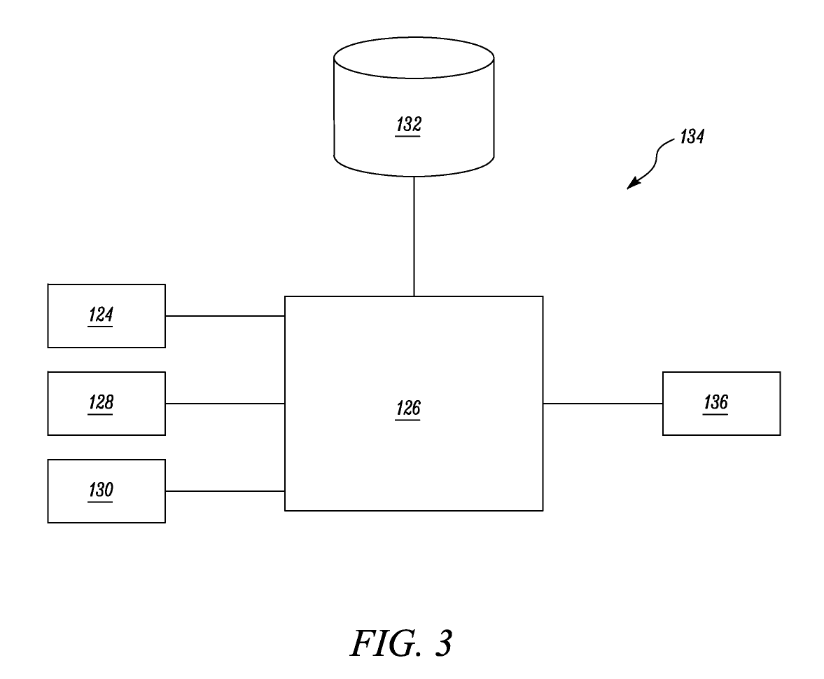

The machine 100 also includes one or more input devices 124 (see FIG. 3) for controlling a transmission of the machine 100 and hoisting of the payload carrier 116 relative to the rear frame 114 of the machine 100, respectively. In one embodiment, the input device 124 may be placed in the operator cabin 108. For example, any of the input devices 124 can include a lever, a joystick, a switch, a button, a touchscreen, keypad, or the like. The input device 124 may be communicably coupled to a controller 126 (see FIG. 3) of the machine 100. Based on an input received from the operator, such as a change in position of the input device 124, the input device 124 may send control signals to the controller 126, indicative of an operator command for transmission control and/or hoisting control of the machine 100. Based on the input from the operator, the machine 100 may operate in any one of a park, reverse, neutral, and drive mode. For example, in the drive mode the machine 100 may move on a worksite in order to reach a loading location. Further, when a loading operation is being performed, the machine 100 may be in the park mode, so that while the loading operation is being performed, the machine 100 continues to remain stationary.

The controller 126 may embody a single microprocessor, or multiple microprocessors that include a means for controlling and operating components of the light indicator system 134 or the machine 100. Numerous commercially available microprocessors may be configured to perform the functions of the controller 126. It should be appreciated that the controller 126 could readily embody a general microprocessor capable of controlling numerous machine functions. The controller 126 may include a database 132, a memory, a secondary storage device, a processor, and any other components for running an application. Various other circuits may be associated with the controller 126 such as a power supply circuit, a signal conditioning circuit, a driver circuit, and other types of circuits.

As shown in FIG. 3, a transmission module 128 may be communicably coupled to the controller 126. The transmission module 128 is configured to generate a signal indicative of the mode of operation of the machine 100. In one embodiment, the transmission module 128 may include, but not limited to, a sensor, for example, a position sensor, an accelerometer, an inclinometer, a tilt sensor, and/or a pressure sensor. The transmission module 128 is associated with a transmission system of the machine 100. The transmission module 128 may determine the mode of operation of the machine 100 based on engagement of a gear of the machine 100 or based on a user input via the input device 124. The modes that may be determined by the transmission module 128 may be indicative of whether the machine 100 is being parked or being made to traverse on the worksite. A person of ordinary skill in the art will appreciate that the controller 126 may control a variety of functions on the machine 100.

The machine 100 includes a payload monitoring module 130. The payload monitoring module 130 is configured to estimate a weight or amount of payload present within the payload carrier 116 of the machine 100. Further, the payload monitoring module 130 may be communicably coupled to the controller 126. The payload monitoring module 130 may include a plurality of sensors (not shown). In one example, the plurality of sensors may be configured to generate a signal indicative of the shear forces acting on a beam of the machine 100. In one embodiment, the plurality of sensors may be a piezoelectric sensor. Alternatively, the plurality of sensors may include any one or a combination of strain sensors, and/or load cells known to one skilled in the art. For example, the sensor may be a foil or wire type strain sensor, film type strain sensor, semiconductor strain sensor, bonded resistance strain sensor, capacitive strain sensor, hydraulic load cell, pneumatic load cell, strain gauge load cell, or any other sensor configured to detect and/or measure the amount of the payload. Further, the database 132 may be coupled to the controller 126. The database 132 may store a threshold value of the payload that may be carried by the payload carrier 116. This threshold value may be indicative of a loading capacity of the machine 100 and may vary based on the application and system design.

In one embodiment, the controller 126 may be communicably coupled to a display device (not shown) provided in the operator cabin 108. The display device may be a display system known in the art, such as, a LED device, a LCD device, a CRT monitor, a touchscreen device, etc. The display device may be configured to display and notify the operator of the machine 100 of the amount of the payload on the machine 100. In one embodiment, the controller 126 may be communicably coupled to a control station located remotely with respect to the machine 100. In such an embodiment, the controller 126 may be configured to notify the operator and/or site manager present at the control station of the amount of the payload on the machine 100.

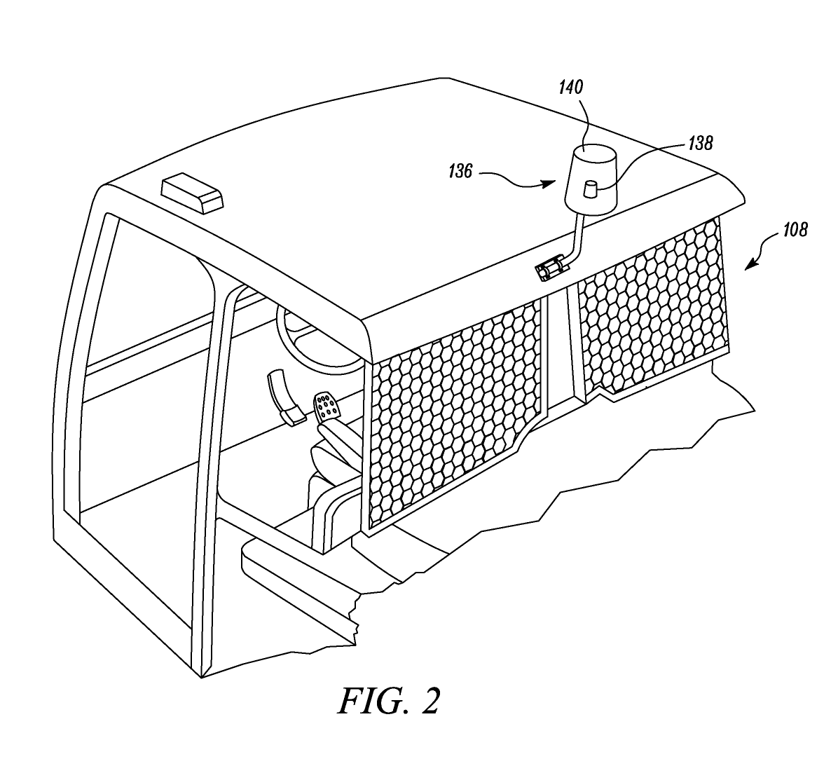

The machine 100 of the present disclosure includes a light indicator system 134. Referring to FIGS. 1, 2, and 3, the light indicator system 134 includes a single light assembly 136. The light assembly 136 is embodied as a visual indication means. The light assembly 136 is a singular assembly which may be positioned on an exterior facing surface of the operator cabin 108 of the machine 100. The light assembly 136 is mounted such that the light assembly 136 is viewable to a person standing outside of the machine 100. In the illustrated embodiment, the light assembly 136 is mounted on a top portion of the operator cabin 108 (shown in FIGS. 1 and 2). Further, the light assembly 136 is communicably coupled to the controller 126. The light assembly 136 may include any known lighting or signaling device capable of illumination, on receiving control signals from the controller 126. The light assembly 136 may embody any of a known incandescent lamp, Light Emitting Diodes (LED), High Intensity Discharge (HID) lamps, neon bulbs, halogen bulbs, xenon lamps, and the like. Referring to FIG. 2, in the illustrated embodiment, the light assembly 136 is an LED strobe including a LED 138 and a cover 140. In one example, the LED 138 may be selected such that the LED 138 is capable of changing colors. Alternatively, the light assembly 136 may include three LED's present within the singular assembly such that each LED is capable of illuminating in distinct colors.

As explained earlier, the controller 126 is communicably coupled to the transmission module 128, and is configured to receive control signals therefrom. The controller 126 is also communicably coupled to the light assembly 136. The light assembly 136 of the light indicator system 134 is operable in a first configuration and a second configuration.

In the first configuration, the light assembly 136 operates as a beacon, in order to indicate a traversal of the machine 100 on the worksite. The light assembly 136 operates in the first configuration when the machine 100 is in the drive mode or is traversing on the worksite in a forward or reverse direction. On determining that the machine 100 is in the drive mode, based on signals received from the transmission module 128, the controller 126 may further send signals to the light assembly 136 to activate the LED 138 of the light assembly 136. Further, in the first configuration, the light assembly 136 is configured to display a first indication in a first color. The first configuration of the LED 138 may include flashing of the LED 138. The first color may include white, amber, yellow, or any other color as required. For example, when the light assembly 136 is activated to operate in the first configuration, the light assembly 136 may operate as a strobe beacon, such that the LED 138 produces regular flashes of amber light. In one embodiment, the LED 138 may also rotate during the traversal of the machine 100.

When the machine 100 switches to the park mode, the controller 126 may send control signals to the light assembly 136 in order to operate the light assembly 136 in the second configuration. In the park mode, the machine 100 may be in a state ready to receive the payload into the payload carrier 116. Accordingly, in the second configuration, the light assembly 136 may indicate or notify the person exterior to the machine 100, about the stationary state of the machine 100. In the second configuration, the light assembly 136 is configured to display a second indication in a second color. The second indication may include a steady or solid light representation. The second color may include any color, such as, green color. In one example, the LED 138 of the light assembly 136 may turn green in color to indicate that the machine 100 is in the park mode. Further, the LED 138 may glow of a steady green color. This may indicate to the person outside of the machine 100 that the machine 100 is ready to be loaded with the payload. Accordingly, the light assembly 136 may indicate to the operator that the machine 100 is parked for the loading operation to begin.

As discussed earlier, the controller 126 of the present disclosure is also communicably coupled to the payload monitoring module 130. The payload monitoring module 130 may estimate the amount of the payload loaded into the payload carrier 116 of the machine 100 during the loading operation. The payload monitoring module 130 may be manually or automatically activated. During the loading operation, the light assembly 136 may continue to be in the second color, for example, the light assembly 136 continues to glow of the green color.

The payload monitoring module 130 may send control signals indicative of the amount of payload present within the payload carrier 116 to the controller 126. The controller 126 may retrieve the predetermined threshold stored within the database 132 and compare the signal of the estimated amount of the payload received from the payload monitoring module 130 with the predetermined threshold.

When the amount of payload being loaded in to the payload carrier 116 exceeds the predetermined threshold, the controller 126 generates a signal indicating an overload condition of the payload carrier 116 of the machine 100. The controller 126 may send signals to the light assembly 136 during the overload condition. Based on the overload condition of the payload carrier 116, the light assembly 136 of the light indicator system 134 is configured to change the display of the LED 138 from the second color to a third color. For example, the LED 138 may change from green color to red color, indicating the overload condition of the payload carrier 116. Further, in one example, the LED 138 may glow of a steady red color.

Once the operator believes that the payload is sufficient, the operator can provide input to the input device 124 to put the machine 100 in the drive mode or begin traversing on the worksite in a forward or reverse direction. On determining that the machine 100 is in the drive mode, based on the signals received from the transmission module 128, the controller 126 may further send signals to the light assembly 136 to activate the LED 138 of the light assembly 136 to the first configuration from the second configuration.

In one embodiment, the light indicator system 134 may also include an audio means associated therewith. The audio means may also be communicably coupled with the controller 126. During the overload condition of the payload carrier 116, the audio means may trigger an alarm sound based on the signals received from the controller 126. The visual and audio means may together notify the person exterior to the machine 100 regarding the overload condition of the payload carrier 116.

It should be noted that the light indications explained above are merely on an illustrative basis and do not limit the scope of the present disclosure. Further, the colors described herein are also exemplary in nature and may vary based on the system requirements. The representation of the light assembly 136 may also vary and is not limited to that described herein. For example, the light assembly 136 may be embodied as a rectangular light extending along a length of a roof portion of the machine 100. Further, there may be modes when the first configuration and the second configuration are not activated as set forth above. For example, when the machine 100 is traversing on the worksite, but the operator places the input device 124 in the park mode or braking mode but not for loading. Here, the controller 126 may send signals to maintain the first configuration, especially when the payload monitoring module 130 sends control signals indicative of the loaded amount of payload present within the payload carrier 116 to the controller 126. Also, when the machine 100 is dumping material from the payload carrier 116, the operator may place the input device 124 in the park mode or braking mode. Here, the controller 126 may send signals to maintain the first configuration, especially when the payload monitoring module 130 sends control signals indicative of the changing loading amount of payload present within the payload carrier 116 to the controller 126.

### INDUSTRIAL APPLICABILITY

In order to perform the loading operation, a loading tool operator present exterior to the machine may need to be made aware of the mode of operation and also a loading status of the machine. An overloaded condition of the machine may affect a service life of the components of the machine and may also lead to damage or breakdown of the machine. Further, a productivity of the loading operation may depend on the skills of the operator external to the machine for loading the machine with an optimum amount of payload. However, the skills and perceptions may vary from one operator to another.

The present disclosure relates to the light indicator system 134. The light assembly 136 of the light indicator system 134 displays the first indication in the first color, when the machine 100 is in the drive mode. Also, when the machine 100 is in the park mode, the controller 126 sends signals to the light assembly 136 to display the second indication in the second color. Further, during the loading operation, if the amount of payload being loaded into the payload carrier 116 exceeds the predetermined threshold, the second color changes to the third color, thereby indicating the overload condition of the machine 100. In another embodiment, the operator can use the input device 124 to manually switch between the first configuration and the second configuration of the light assembly 136. For instance, when the machine 100 is ready for a loading cycle, the operator can switch the input device 124 to a mode to permit the light assembly 136 to operate in the second configuration. Once the operator is ready to leave the loading cycle, the operator can switch the input device 124 to a mode to permit the light assembly 136 to operate in the first configuration.

The light indicator system 134 disclosed herein is compact in size and may be easily retrofitted to an existing machine. Further, the light indicator system 134 is cost effective and has reduced wiring and mounting complexities. The light assembly 136 may be easily assembled onto the machine 100.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A light indicator system for a machine, the system comprising:
a single light assembly positioned on an exterior facing surface of an operator cab of the machine, such that the light assembly is viewable from outside the machine;
a payload monitoring module configured to generate a signal indicative of an amount of payload on the machine;
a transmission module configured to generate a signal indicative of a mode of operation of the machine; and
a controller communicably coupled to the light assembly, the payload monitoring module, and the transmission module, the controller configured to:
receive the signal indicative of the mode of operation of the machine;
activate a first configuration of the light assembly during a traversal of the machine, such that in the first configuration the light assembly is configured to display a first indication in a first color; and
activate a second configuration of the light assembly during a parking of the machine, such that in the second configuration the controller is configured to:
display a second indication in a second color on the light assembly;
receive the signal indicative of the amount of payload;
compare the amount of payload with a predetermined threshold; and
change the second color to a third color based on the amount of payload exceeding the predetermined threshold.
